(19) United States
(12) Patent Application Publication
(10) Pub. No.: US 2008/0053200 A1
(43) Pub. Date: Mar. 6, 2008

(54) Sealing test method, test specimen and test bench

(75) Inventors: Jacques Dhellemmes, Versailles (FR); Nicolas Lefevre, Versailles (FR); Sophie Preato-Pavret De La Rochefordiere, Urrugne (FR); Christophe Huon De Kermadec, Versailles (FR)

Correspondence Address: YOUNG & THOMPSON, 745 SOUTH 23RD STREET, 2ND FLOOR, ARLINGTON, VA, 22202, US

(73) Assignee: GAZTRANSPORT ET TECHNIGAZ, SAINT REMY LES CHEVREUSE (FR)

(21) Appl. No.: 11/826,563

(22) Filed: Jul. 17, 2007

(30) Foreign Application Priority Data
Sep. 6, 2006 (FR) 06/07817

(51) Int. Cl. G01M 3/04

(52) U.S. Cl. 73/49.8

(57) ABSTRACT

Method for testing the sealing of a test specimen (21) comprising a sealing film and two fibrous reinforcing layers, one on each side of the said sealing film, the said method comprising the steps of:
connecting the said test specimen to a test bench (22),
conducting a first test of behaviour under pressure,
subjecting the said test specimen to at least a first thermal shock, and
conducting at least a second test of behaviour under pressure,

characterized in that the said method comprises at least the steps of:
removing the said test specimen from the said test bench after the said first test of behaviour under pressure, and subjecting the said test specimen to the said first thermal shock remotely from the said test bench, and
refixing the said test specimen to the said test bench to conduct the said second test of behaviour under pressure.

The present invention relates to a method for testing the sealing of a test specimen, and also to a test specimen and a test bench for the application of the method.

French patent application 2 724 623 proposes a thermally insulated sealed container integrated in a supporting structure, in particular a supporting structure of a ship. The wall of the container has, in sequence from the inside of the container towards the supporting structure, a primary sealing barrier in contact with the product contained in the container, a primary thermal insulation barrier, a secondary sealing barrier and a secondary thermal insulation barrier. The secondary sealing barrier and the secondary thermal insulation barrier are essentially composed of a set of prefabricated panels fixed to the supporting structure, each panel being formed, firstly, from a first rigid plate carrying a layer of thermal insulation which combines with it to form a secondary thermal insulation barrier; secondly, from a sealing sheet adhering to substantially the whole surface of the thermal insulation layer of the aforesaid secondary thermal insulation barrier, the said sheet being made from a composite material whose two outer reinforcing layers are glass fibre textiles and whose intermediate layer is a thin deformable aluminium film with a thickness of 0.1 mm, the said sealing sheet forming a secondary sealing barrier element; thirdly, from a second thermal insulation layer, which partially covers the aforesaid sheet and which adheres to it; and, fourthly, from a second rigid plate covering the second thermal insulation layer and combining with it to form a primary thermal insulation barrier element.

The areas between two adjacent panels are filled so as to make the secondary sealing barrier continuous. More precisely, in order to provide continuity of sealing of the secondary sealing barrier, the adjacent peripheral edges of two adjacent panels are covered, in line with the joints between the panels, with a strip of sealing sheet, also having three layers, the said strip adhering to the two adjacent peripheral edges and making the seal continuous by means of its metal film.

The quality of the seal of the secondary sealing barrier depends on a number of factors, particularly the quality of the sealing sheet used for the fabrication of the panels and for forming the joint between two panels and the seal of the bonding.

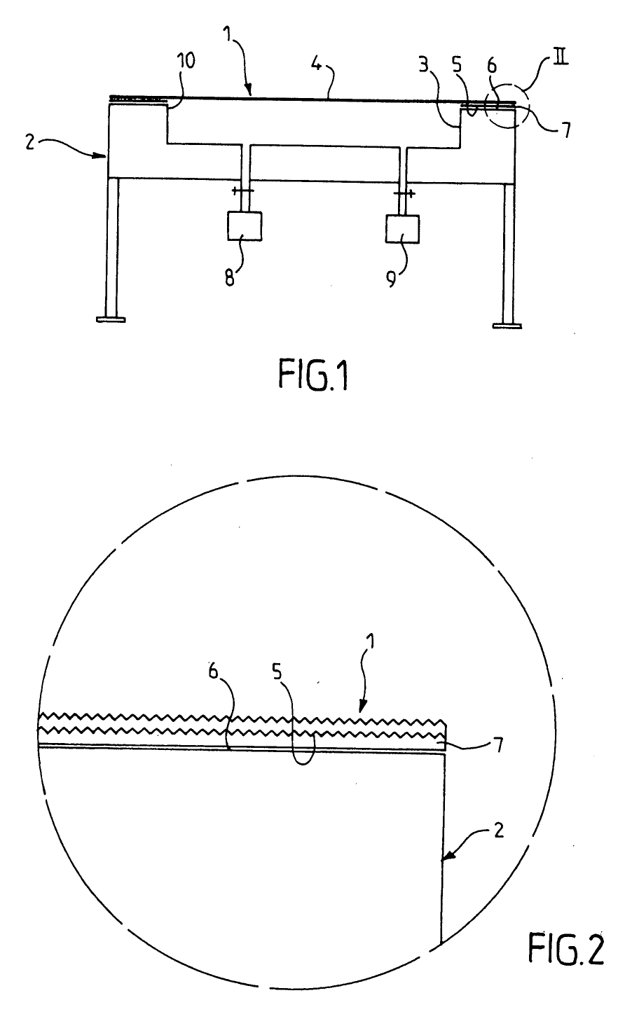

To ensure adequate sealing, there is a known way of conducting a sealing test on a test specimen of sealing sheet. FIGS. 1 and 2 show a test bench 2 and a test specimen 1 for applying a sealing test method according to the prior art.

The test specimen 1 comprises a sealing film, for example a thin aluminium film, placed between two reinforcing layers, for example glass fibre textiles. In the remainder of this description, the assembly formed by the sealing film and the reinforcing layers is called the “sheet”. The sheet of the test specimen 1 has a connecting surface 5 which surrounds an area to be tested 4. The test method is intended to test the sealing of the test specimen 1, using a test bench 2.

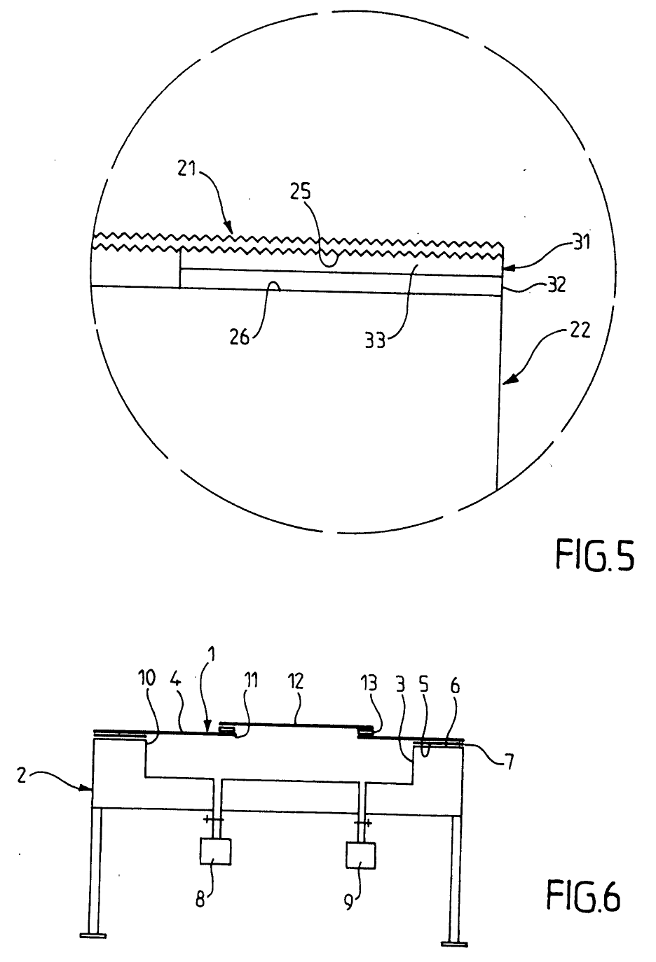

In a variant shown in FIG. 6, the sheet of the test specimen 1 has an opening 11 in the area to be tested 4. The opening 11 is covered by a membrane 12 composed of three layers similar to those of the sheet. The membrane is bonded to the sheet all round the opening 11. This makes it possible to test the quality of the sealing of the bond 13 between the membrane 12 and the sheet.

The test bench 2 comprises a vacuum chamber 3 which has an opening 10. A vacuum pump 8 and a pressure sensor 9 are connected to the vacuum chamber 3. The test bench 2 has a connecting surface 6 which surrounds the opening 10 of the vacuum chamber 3.

The known test method comprises the fixing of the test specimen 1 to the test bench 2 with an adhesive joint 7 which joins, in a substantially sealed way, the connecting surface 5 of the test specimen 1 to the connecting surface 6 of the test bench 2.

The vacuum pump 8 is then operated to reduce the pressure in the vacuum chamber 3 to a specified level. The operation of the vacuum pump 8 is then halted, and the pressure sensor 9 is used to determine the pressure rise curve in the vacuum chamber 3. This is a first test of behaviour under pressure.

The test specimen 1 is then subjected to a first thermal shock, consisting in abruptly reducing the temperature of the test specimen 1 by a large amount, by pouring a layer of liquid nitrogen over it. The temperature of the test bench 2, which is connected to the test specimen 1, is also reduced. The liquid nitrogen evaporates naturally and the operator waits for the test specimen 1 and the test bench 2 to return to ambient temperature.

A second test of behaviour under pressure is then conducted. By subsequently alternating thermal shocks and tests of behaviour under pressure, it is possible to evaluate the initial degree of sealing of the test specimen 1 and the variation of this degree of sealing under the effect of thermal shocks.

This known method has a number of drawbacks. In the first place, the accuracy of measurement is limited by the effect of the imperfect seal formed by the adhesive joint 7, particularly in the case of a test specimen 1 whose reinforcing layers are made from fibrous material which has a degree of porosity. The repeatability of the measurements is also limited because of the large number of manual operations required, particularly for fixing the test specimen 1 to the test bench 2. This large number of operations not only increases the duration of the process, particularly since it is necessary to wait for the polymerization of the adhesive joint 7, but also raises the cost of the process. The duration of the process is also affected by the duration of the thermal shocks which take a relatively long time to produce. Since the test bench is subjected to the thermal shocks, it tends to become progressively degraded. The effect of this degradation on the measurement is difficult to gauge and cannot be distinguished from that of the test specimen itself. Moreover, the removal of the test specimen 1 at the end of the process entails its destruction, making it impossible to conduct a counter-test subsequently. At the end of the process, the test bench has to be cleaned to remove residues of the adhesive joint, before another test specimen can be tested.

Documents U.S. Pat. No. 4,979,390, BE 653 074, U.S. Pat. No. 4,409,818, FR 2 172 321, GB 895 063, U.S. Pat. No. 2,108,179, and U.S. Pat. No. 4,246,775 describe different sealing test devices and methods. As a general rule, a sealing gasket is provided on the test device, so as to form a substantially sealed connection by contact between the sealing gasket of the test device and the element to be tested.

However, none of these documents shows how to test the sealing of a test specimen comprising a fibrous reinforcing layer. This is because, if a sealing gasket is simply placed in contact with the fibrous reinforcing layer of a test specimen, leaks can occur between the sealing gasket and the fibrous layer, and also along the fibres within the fibrous layer. It is difficult to determine the extent to which the measured degree of sealing is affected by these leaks.

The object of the invention is to provide a method which is free of at least some of the aforesaid drawbacks of the prior art.

The invention therefore provides a method for testing the sealing of a test specimen comprising a sealing film and at least one fibrous reinforcing layer adjacent to the said sealing film, the said method comprising the steps of:
fixing the said test specimen to a test bench comprising a vacuum chamber in such a way that an area of the said test specimen to be tested covers an opening of the said vacuum chamber, a connecting surface of the said test specimen surrounding the said area to be tested being connected by sealing means to a connecting surface of the said test bench which surrounds the said opening,
conducting a first test of behaviour under pressure, comprising the reduction of pressure in the said vacuum chamber, and the measurement of the pressure in the said vacuum chamber,
subjecting the said test specimen to at least a first thermal shock, and
conducting at least a second test of behaviour under pressure,

characterized in that the said sealing means can enable the said test specimen to be separated from the said test bench in a non-destructive way, the said method comprising at least the steps of:
removing the said test specimen from the said test bench after the said first test of behaviour under pressure, and subjecting the said test specimen to the said first thermal shock remotely from the said test bench, and
refixing the said test specimen to the said test bench to conduct the said second test of behaviour under pressure.

Because of these features, the test bench is not subjected to any thermal shock. The measurements cannot be interfered with by any degradation of the test bench. Furthermore, the measurements can be made in rapid succession, since the thermal inertia of the test bench does not affect the outcome. At the end of the process, the test specimen can be preserved, making it possible to conduct a counter-test subsequently and thus to retain a reference.

Preferably, the said sealing means comprise a first sealing gasket fixed to the said test specimen, and a second sealing gasket fixed to the said test bench, the said first and second sealing gaskets being capable of forming a substantially sealed connection by contact.

Thus the reliability, the accuracy and the repeatability of the measurements are improved, since the effect of the sealing of the sealing means can be quantified. Moreover, the operations and the start and end of the process are very simple and quick. In particular, it is not necessary to wait for the polymerization of an adhesive at the start of the process, and no cleaning operation is necessary at the end of the process.

Advantageously, when the said test specimen is removed from the said test bench to be subjected to a thermal shock, the said method comprises fixing a second test specimen to the said test bench and conducting a test of behaviour under pressure with the said second test specimen.

The utilization of the test bench is improved. This makes it possible to reduce the number of test benches required for a given volume of production.

The invention also provides a test specimen comprising a sealing film and at least one fibrous reinforcing layer adjacent to the said sealing film, the said test specimen having an area to be tested, characterized in that it comprises a sealing gasket which surrounds the said area to be tested, the said sealing gasket being capable of forming a substantially sealed connection by contact with a sealing gasket of a test bench.

By providing a test specimen which has its own sealing gasket, it is possible to control the sealing at the position of this gasket. For example, a high degree of sealing can be provided by using a gasket which impregnates the fibres of the fibrous reinforcing layer, with polyurethane adhesive for example. Thus, when this test specimen is placed on a test bench, the effect of any leaks at the sealing gasket is quantifiable.

Preferably, the said sealing gasket is adjacent to at least one edge of the said test specimen.

In one embodiment, the test specimen comprises two fibrous reinforcing layers, one on each side of the sealing film.

In a specific embodiment, the said sealing gasket covers a portion of the surface of one of the said reinforcing layers, while the thickness of the said test specimen at its periphery is not covered by the sealing gasket. Alternatively, the said sealing gasket covers a portion of the surface of one of the said reinforcing layers and the thickness of the said test specimen at its periphery.

In the first case, this makes it possible to measure the degree of sealing of the test specimen both in terms of transverse sealing, in other words perpendicularly to the surface of the test specimen, and in terms of tangential sealing, in other words parallel to the surface of the test specimen, which, in the case of reinforcing layers of fibrous material, is due to the porosity imparted by the fibres. In the second case, only the degree of transverse sealing is considered.

Preferably, the said sealing gasket covers a portion of the surface of the other of the said reinforcing layers.

Advantageously, the test specimen has a substantially circular shape, the said sealing gasket having a substantially annular shape.

These features facilitate the production of the sealing gasket, improve the quality of the substantially sealed connection formed by contact with the sealing gasket of a test bench, and improve the resistance of the test specimen to thermal shocks.

In a specific embodiment, the said sealing gasket is overmoulded on or bonded to the assembly formed by the said sealing film and the said reinforcing layers.

Advantageously, the said sealing gasket is made from a material which has a coefficient of expansion and an acceptable cold deformation which are compatible with those of the assembly formed by the said sealing film and the said reinforcing layers. For example, it is made from polyurethane adhesive or rubber.

The invention also provides a test bench for a test specimen, comprising a sealing film and two reinforcing layers, one on each side of the said sealing film, the said test bench comprising a vacuum chamber which has an opening intended to be covered by an area of the said test specimen to be tested, characterized in that it comprises a sealing gasket which surrounds the said opening, the said sealing gasket being capable of forming a substantially sealed connection by contact with a sealing gasket of the said test specimen.

Preferably, the test bench comprises fixing means which can bear on the said test specimen so as to press the sealing gasket of the test specimen against the sealing gasket of the test bench.

The invention will be made more comprehensible and other objects, details, features and advantages thereof will be clarified by the following description of a specific embodiment of the invention, provided solely for guidance and without restrictive intent, with reference to the attached drawings. In these drawings:

FIG. 1 is a schematic view of a test bench and of a test specimen according to an embodiment of the prior art,

FIG. 2 shows a detail of FIG. 1,

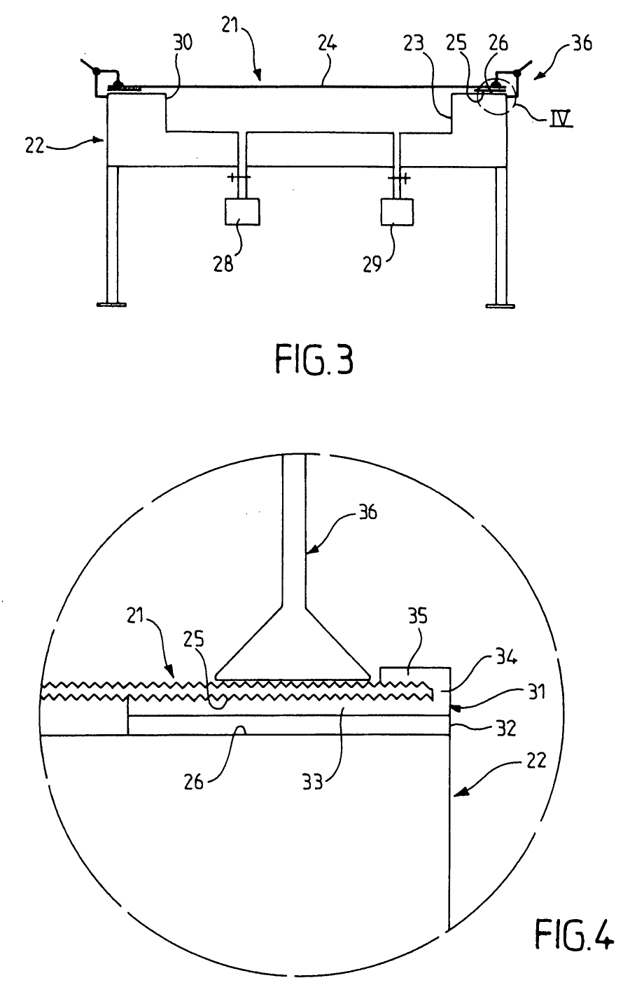

FIG. 3 is a schematic view of a test bench and of a test specimen according to one embodiment of the invention,

FIG. 4 shows a detail of FIG. 3,

FIG. 5 is a view, similar to that of FIG. 4, of a variant embodiment, and

FIG. 6 shows the test bench of FIG. 1, to which a prior art test specimen is fixed, in a variant.

FIGS. 3 to 5 show a test bench and a test specimen for the application of a sealing test method according to one embodiment of the invention. Elements which are identical or similar to elements of the embodiment of FIGS. 1 and 2 are indicated by the same reference numerals, increased by 20, and are not described in greater detail.

The test specimen 21 comprises a sealing film and two reinforcing layers, one on each side of the said sealing film. The sealing film can be made from metal, for example aluminium, or from any other sealing material. The reinforcing layers are fibrous; for example, they may be glass fibre textiles. In the remainder of this description, the assembly formed by the sealing foil and the reinforcing layers is called the “sheet”. The sheet is preferably of circular shape and has a central area 24 to be tested. The test specimen 21 also comprises an annular sealing gasket 31 which surrounds the said area to be tested 24. Alternatively, the sheet could have another shape, being square for example. In this case, the sealing gasket is also square and is adjacent to each edge of the sheet.

As shown in FIG. 4, the sealing gasket 31 has three portions: a contact portion 33 covers a connecting surface 25 of the sheet which surrounds the area to be tested 24, a thickness portion 34 extends parallel to the thickness of the sheet and surrounds its periphery, and a cover portion 35 covers the edge of the sheet opposite the contact portion 33. In a variant shown in FIG. 5, only the contact portion 33 is provided.

The sealing gasket 31 is, for example, overmoulded, in other words moulded around the sheet, or bonded to the sheet. It is made from a material which withstands cryogenic temperatures, in other words one which does not suffer damage in the form of hairline cracks or fragility when subjected to thermal shock, and which has a coefficient of deformation and an acceptable cold deformation which are compatible with those of the sheet, in other words of the same order of magnitude, to prevent the thermal shock from damaging the test specimen 21. For example, the sealing gasket 31 is made from polymerized polyurethane adhesive or rubber. In one embodiment, the sealing gasket 31 impregnates the fibres of the reinforcing layers.

In a variant which is not shown, the sheet of the test specimen 21 has an opening in the area to be tested 24, in a similar way to what was described with reference to FIG. 6. The opening is covered by a membrane composed of three layers similar to those of the sheet. The membrane is bonded to the sheet all round the opening. This makes it possible to test the quality of the sealing of the bond between the membrane and the sheet.

The test bench 22 also has its own sealing gasket 32, fixed for example by bonding to a connecting surface 26 which surrounds the opening 30 of the vacuum chamber 23. As explained below, the sealing gasket 32 is not subjected to thermal shocks. It can be made, for example, from rubber, from closed cell foam, or from vacuum sealing resin. In the illustrated embodiment, the test bench 22 also comprises a press 36. In another embodiment, the press 36 is omitted.

The test method according to one embodiment of the invention comprises the fixing of the test specimen 21 to the test bench 22 by placing the contact portion 33 of the sealing gasket 31 in contact with the sealing gasket 32, the area to be tested 24 covering the opening 30. The press 36 is operated so as to press the sealing gasket 31 against the sealing gasket 32 so as to form a substantially sealed connection by contact. In the variant in which the press 36 is omitted, the contact between the sealing gasket 31 and the sealing gasket 32 and the vacuum created in the vacuum chamber 23 are sufficient to connect the test specimen 21 to the test bench 22.

A first test of behaviour under pressure is then conducted, by a similar procedure to what is described above with reference to the prior art method, but this procedure is not essential to the application of the invention.

The test specimen 21 is then separated from the test bench 22. This separation is carried out without destruction of the test specimen 21 or of the test bench 22: the sealing gasket 31 remains fixed to the sheet and is separated from the sealing gasket 32 which remains fixed to the rest of the test bench 22.

A first thermal shock is then imparted to the test specimen 21, remotely from the test bench which is therefore not subjected to thermal shock. During this time, the test bench 22 can be used to conduct a test of behaviour under pressure with another test specimen. The thermal shock can be produced by pouring liquid nitrogen on to the test specimen 21, or in any other suitable way.

The test specimen 21 is then refixed to the test bench 22, and a second test of behaviour under pressure is conducted. By subsequently alternating thermal shocks and tests of pressure behaviour, it is possible to evaluate the initial degree of sealing of the test specimen 21 and the variation of this degree of sealing under the effect of a cycle of thermal shocks.

Clearly, although the invention has been described with reference to a particular embodiment, it is not limited in any way by this, and comprises all the technical equivalents of the means described and their combinations where these fall within the scope of the invention.

1. Method for testing the sealing of a test specimen (21) comprising a sealing film and at least one fibrous reinforcing layer adjacent to the said sealing film, the said method comprising the steps of:
fixing the said test specimen to a test bench (22) comprising a vacuum chamber (23) in such a way that an area (24) of the said test specimen to be tested covers an opening (30) of the said vacuum chamber, a connecting surface (25) of the said test specimen surrounding the said area to be tested being connected by sealing means (31, 32) to a connecting surface (26) of the said test bench which surrounds the said opening,
conducting a first test of behaviour under pressure, comprising the reduction of pressure in the said vacuum chamber, and the measurement of the pressure in the said vacuum chamber,
subjecting the said test specimen to at least a first thermal shock, and
conducting at least a second test of behaviour under pressure,
characterized in that the said sealing means enable the said test specimen to be separated from the said test bench in a non-destructive way, the said method comprising at least the steps of:
removing the said test specimen from the said test bench after the said first test of behaviour under pressure, and subjecting the said test specimen to the said first thermal shock remotely from the said test bench, and
refixing the said test specimen to the said test bench to conduct the said second test of behaviour under pressure.

2. Sealing test method according to claim 1, characterized in that the said sealing means comprise a first sealing gasket (31) fixed to the said test specimen, and a second sealing gasket (32) fixed to the said test bench.

3. Sealing test method according to claim 1, characterized in that, when the said test specimen is removed from the said test bench to be subjected to a thermal shock, the said method comprises fixing a second test specimen to the said test bench and conducting a test of behaviour under pressure with the said second test specimen.

4. Test specimen (21) comprising a sealing film and at least one fibrous reinforcing layer adjacent to the said sealing film, the said test specimen having an area to be tested (24), characterized in that it comprises a sealing gasket (31) which surrounds the said area to be tested.

5. Test specimen according to claim 4, characterized in that the said sealing gasket is adjacent to at least one edge of the said test specimen.

6. Test specimen according to claim 4, characterized in that the said sealing gasket covers a portion of the surface of the said reinforcing layer, the thickness of the said test specimen at its periphery not being covered by the sealing gasket.

7. Test specimen according to claim 4, characterized in that the said sealing gasket covers a portion of the surface of the said reinforcing layer and the thickness of the said test specimen at its periphery.

8. Test specimen according to claim 7, characterized in that it comprises two fibrous reinforcing layers, one on each side of the said sealing film, the said sealing gasket covering a portion of the surface of the other of the said reinforcing layers.

9. Test specimen according to claim 4, characterized in that it has a substantially circular shape, the said sealing gasket having a substantially annular shape.

10. Test specimen according to claim 4, characterized in that the said sealing gasket is overmoulded on or bonded to the assembly formed by the said sealing film and the said reinforcing layer.

11. Test specimen according to claim 4, characterized in that the said sealing gasket is made from a material which has a coefficient of expansion and an acceptable cold deformation which are compatible with those of the assembly formed by the said sealing film and the said reinforcing layer.

12. Test specimen according to claim 11, characterized in that the said sealing gasket is made from polyurethane adhesive or rubber.

13. Test specimen according to claim 4, in which the said sealing gasket impregnates the fibres of the said at least one reinforcing layer.

14. Sealing test method according to claim 2, characterized in that, when the said test specimen is removed from the said test bench to be subjected to a thermal shock, the said method comprises fixing a second test specimen to the said test bench and conducting a test of behaviour under pressure with the said second test specimen.

15. Test specimen according to claim 5, characterized in that the said sealing gasket covers a portion of the surface of the said reinforcing layer, the thickness of the said test specimen at its periphery not being covered by the sealing gasket.

16. Test specimen according to claim 5, characterized in that the said sealing gasket covers a portion of the surface of the said reinforcing layer and the thickness of the said test specimen at its periphery.

17. Test specimen according to claim 5, characterized in that it has a substantially circular shape, the said sealing gasket having a substantially annular shape.

18. Test specimen according to claim 5, characterized in that the said sealing gasket is overmoulded on or bonded to the assembly formed by the said sealing film and the said reinforcing layer.

19. Test specimen according to claim 5, characterized in that the said sealing gasket is made from a material which has a coefficient of expansion and an acceptable cold deformation which are compatible with those of the assembly formed by the said sealing film and the said reinforcing layer.

20. Test specimen according to claim 5, in which the said sealing gasket impregnates the fibres of the said at least one reinforcing layer.
